(19) United States
(12) Patent Application Publication
(10) Pub. No.: US 2018/0349833 A1
(43) Pub. Date: Dec. 6, 2018

(54) MANAGING USAGE OF CARGO TRANSPORTATION UNITS

(71) Applicant: BlackBerry Limited, Waterloo (CA)

(72) Inventors: Conrad Delbert Seaman, Ottawa (CA); Stephen West, Manotick (CA); Prabhul Dev, Ottawa (CA)

(21) Appl. No.: 15/615,213

(22) Filed: Jun. 6, 2017

(51) Int. Cl. G06Q 10/08; G06Q 50/28; B65D 90/48; B65D 79/02

(52) U.S. Cl. CPC G06Q 10/083; G06Q 50/28; B65D 88/12; B65D 79/02; B65D 90/48

(57) ABSTRACT

In some examples, a system manages usage of cargo transportation units (CTUs) based on usage characteristics of the CTUs and target usage factors relating to the CTUs, wherein the managing includes selecting a CTU from among the CTUs to use for a cargo delivery job.

### BACKGROUND

Trucks, tractor-trailers, or tractors that are connected to chassis for carrying containers can be used to transport cargo that includes goods. Cargo can be transported from an origin (such as a factory, a warehouse, a retail outlet, etc.) to a destination (such as retail outlet, a warehouse, customer premises, etc.) along a route. For an enterprise (e.g., a shipper, a distributor, a manufacturer, etc.) that has a fleet of cargo transportation units (CTUs), the CTUs may not be efficiently used.

### BRIEF DESCRIPTION OF THE DRAWINGS

Some implementations of the present disclosure are described with respect to the following figures.

FIG. 1 is a block diagram of an example arrangement including cargo transportation units (CTUs) and a system including a CTU distribution management engine, according to some implementations.

FIGS. 2 and 3 are flow diagrams of example CTU distribution management processes, according to various implementations.

FIG. 4 is a block diagram of a system according to some implementations.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

A cargo transportation unit (CTU) in the form of a moveable platform can be used to carry cargo items between different geographic locations. A “cargo item” can refer to any physical item that is to be delivered from one location to another location. “Cargo” can refer to one or more cargo items. In some examples, a CTU can be a container (that is attached to a tractor), a cargo carrying portion of a truck, or a trailer, where the container provides an enclosed space in which the physical items can be stored during shipment. In other examples, the CTU can include another type of carrier structure that is able to carry cargo items. More generally, the CTU can be part of, mounted on, or attached, as applicable, to a vehicle, such as a truck, a trailer, a tractor, a car, a railed vehicle (e.g., a train), a watercraft (e.g., a ship), an aircraft, a spacecraft, and so forth. The vehicle can haul the CTU that is part of, mounted on, or attached to the vehicle.

An enterprise can manage a fleet of CTUs. Examples of enterprises include shippers, manufacturers, distributors, retailers, individuals, or any other entity that is responsible for managing a fleet of CTUs, which can be owned by the entity or can be owned by one or more other entities.

The CTUs of the fleet may be dispersed across a number of geographic locations (e.g., in many cities, states, provinces, countries, etc.). In addition, different CTUs of the fleet can have different capabilities and different characteristics. Different cargo delivery jobs (where a cargo delivery job can refer to a task or a collection of tasks associated with transporting cargo between an origin and a destination) can have respective different requirements. If CTUs are not properly matched to the requirements of corresponding cargo delivery jobs, then the result may be inefficient usage of the CTUs in the fleet, which can lead to increased delivery times, reduced operating efficiencies, increased costs, and so forth.

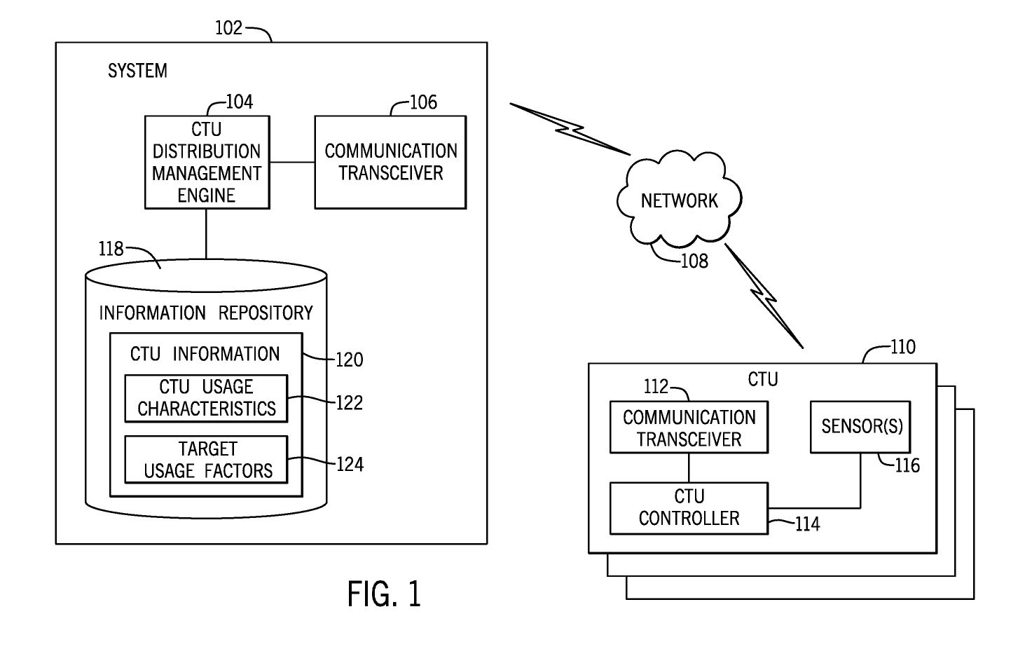

In accordance with some implementations of the present disclosure, as depicted in FIG. 1 in some examples, a system 102 includes a CTU distribution management engine 104 to manage the usage of CTUs in a fleet of CTUs. Although reference is made to a “fleet” of CTUs, it is noted that the term “fleet” can refer to any collection of CTUs, whether the CTUs are owned by one entity or owned by multiple entities.

The term “engine” can refer to a hardware processing circuit, which can be a microprocessor, a core of a multi-core microprocessor, a microcontroller, a programmable gate array, a programmable integrated circuit device, or any other hardware processing circuit. Alternatively, the term “engine” can refer to a combination of a hardware processing circuit and machine-readable instructions executable on the hardware processing circuit.

The system 102 can be implemented as a computer system or as a distributed arrangement of computer systems. The computer system(s) can be part of a server system, which can be located in a cloud network, located in an enterprise network, and so forth.

The system 102 includes a communication transceiver 106 to allow the system 102 to communicate over a network 108 with CTUs 110. The network 108 can be a wireless network in some examples.

A wireless network can include a cellular network or a wireless local area network (WLAN). An example cellular network can operate according to the Long-Term Evolution (LTE) standards as provided by the Third Generation Partnership Project (3GPP). The LTE standards are also referred to as the Evolved Universal Terrestrial Radio Access (E-UTRA) standards. In other examples, other types of cellular networks can be employed, such as second generation (2G) or third generation (3G) cellular networks, e.g., a Global System for Mobile (GSM) cellular network, an Enhanced Data rates for GSM Evolution (EDGE) cellular network, a Universal Terrestrial Radio Access Network (UTRAN), a Code Division Multiple Access (CDMA) 2000 cellular network, and so forth. In further examples, cellular networks can be fifth generation (5G) or beyond cellular networks.

A WLAN can operate according to the Institute of Electrical and Electronic Engineers (IEEE) 802.11 or Wi-Fi Alliance Specifications. In other examples, other types of wireless networks can be employed, such as a Bluetooth link, a ZigBee network, and so forth. Additionally, some wireless networks can enable cellular IoT, such as wireless access networks according to LTE Advanced for Machine-Type Communication (LTE-MTC), narrowband IoT (NB-IoT), and so forth.

In the example of FIG. 1, each CTU 110 can include a communication transceiver 112 to communicate over the network 108 with the system 102. The CTU 110 can also include a CTU controller 114, which can be implemented as a hardware processing circuit or a combination of hardware processing circuit and machine-readable instructions executable on the hardware processing circuit.

The CTU 110 can also include one or more sensors 116, which can gather various information regarding operation of the CTU 110, an environment of the CTU 110, and so forth. In some examples, the CTU controller 114 can control various operations of the CTU 110. In other examples, the CTU controller 114 can receive measurement data from the one or more sensors 116, and send such measurement data through the communication transceiver 112 to the system 102.

The system 102 also includes an information repository 118, which can be implemented as a storage medium (or multiple storage media). For example, the information repository 118 can be implemented using one or more disk-based storage devices and/or one or more solid state storage devices.

The information repository 118 can store CTU information 120, which includes information regarding each of the CTUs 110 in a fleet of CTUs managed by the CTU distribution management engine 104. The CTU information 120 can include CTU usage characteristics 122 and target usage factors 124.

The usage characteristics of CTUs can refer to characteristics of the CTUs that relate to use or operation of the CTUs. The target usage factors 124 relating to CTUs can refer to requirements or goals associated with using CTUs.

Examples of the CTU usage characteristics 122 include any or some combination of the following: an age of a CTU, a time since a most recent use of a CTU, a maintenance status of a CTU (e.g., a time of a most recent maintenance of the CTU, a maintenance history of the CTU including types of maintenance performed and repairs performed, a time of a next scheduled maintenance, a cost to maintain the CTU, etc.), a frequency of use of a CTU, and a lease status of a CTU (e.g., whether the CTU is leased from a third party, a length of the lease, an expiration date of the lease, a maximum number of miles specified by the lease, a cost per distance of using the leased CTU is higher or lower than that of another CTU, a cost per distance that increases or decrease with increasing time, age, use, or maintenance, etc.).

Examples of the target usage factors 124 can include any or some combination of the following: a goal of reducing a downtime of a CTU, a goal of reducing a distance to a repair facility of a CTU, a goal of reducing a distance to pick up a CTU, a goal of reducing usage of a CTU, a goal of increasing usage of a CTU, and a goal of balancing usage of CTUs in a fleet.

A goal of reducing a downtime of a CTU can refer to reducing an amount of time when a CTU is not being used for delivery cargo. Some CTUs in the fleet may have been inactive longer than other CTUs. To satisfy the goal of reducing a downtime of a CTU, a CTU that has been idle longer may be selected by the CTU distributed management engine 104 for a cargo delivery job over another CTU that has been idle for a smaller amount of time.

A goal of reducing a distance to a repair facility of a CTU can refer to ensuring that the CTU is not moved away (by greater than a specified distance) from a specific repair facility (or repair facilities) in performing a cargo delivery job. For example, a CTU usage characteristic may indicate that a given CTU is old (older than a specified age), or that it has been a while (greater than a specified time duration) since a last scheduled maintenance for the given CTU, or that a time to a next scheduled maintenance of the given CTU is close (within a specified time duration). In such scenarios, to satisfy the goal of reducing a distance to a repair facility of the given CTU, the given CTU may be selected by the CTU distributed management engine 104 for use in a cargo delivery job that does not move the given CTU by greater than a specified distance from one or more repair facilities. For example, the given CTU can be selected for a cargo delivery job that transports cargo locally within a city, or that transports cargo along a route between an origin and a destination that has multiple repair facilities each of which is accessible by the given CTU without traveling by greater than the specified distance at any point along the route. Ensuring that the CTU is within the specified distance of a repair facility ensures that the distance traveled for repair is lower in case of a breakdown or other problem experienced by the CTUs.

In contrast, younger CTUs or more recently maintained CTUs can be selected by the CTU distributed management engine 104 for cargo delivery jobs that travel longer distances, since such CTUs are generally more reliable.

A goal of reducing a distance to pick up a CTU can refer to reducing the distance that an available vehicle (such as a tractor) has to travel to pick up the CTU to perform a cargo delivery job. For example, there are a number of vehicles available that can be used to haul a CTU for a given cargo delivery job. To satisfy the goal of reducing a distance to pick up a CTU, the CTU distributed management engine 104 can select a CTU, from among multiple CTUs, that is closest (or closer) to any of the available vehicles.

A goal of reducing usage of a CTU can refer to a goal to reduce the amount of instances where a specific CTU is selected for cargo delivery jobs. Certain CTUs may have characteristics that make them less desirable for use. For example, certain CTUs may be more costly to maintain, may have not been maintained for a relatively long period of time or may be close to a next scheduled maintenance, may have an older age, may be less fuel efficient, may be leased, and so forth. The CTU distributed management engine 104 can attempt to reduce the usage of such CTUs, since it may not be efficient or desirable to operate a CTU that is old, or that has not been maintained for a relatively long period of time, or that is close to a next scheduled maintenance, or that is leased (e.g., the CTU may be approaching a maximum travel distance allowed by terms of the lease).

A goal of increasing usage of a CTU can refer to a goal to increase the amount of instances where a specific CTU is selected for cargo delivery jobs. Certain CTUs may have characteristics that make them more desirable for use. For example, certain CTUs may be less costly to maintain, may have not been recently maintained or may be far in time to a next scheduled maintenance, may have a younger age, may be more fuel efficient, may be leased, and so forth. The CTU distributed management engine 104 can attempt to increase the usage of such CTUs, since it may be more efficient or desirable to operate a CTU that is young, or that has been maintained a short time ago, or that is far in time to a next scheduled maintenance, or that is leased (e.g., the CTU has a lot of kilometers left before the CTU reaches a maximum travel distance allowed by terms of the lease).

A goal of balancing usage of CTUs in a fleet can refer to attempting to balance usage of CTUs in a fleet (or a subset of the fleet) such that the CTUs of the fleet (subset) are used by an approximate uniform amount (number of instances selected for use, amount of distance traveled for cargo delivery jobs, etc.). Balancing usage of CTUs can help with maintenance and uniformity. For example, a company can determine that the company can save cost by bringing CTUs in every 9 months instead of 6 months for maintenance, which can be achieved by balancing CTU usage so that there is even wear of CTUs. Additionally, more balanced usage of CTUs can allow for creation or usage of simple financial models for costs such as depreciation.

In further examples, a target usage factor 124 includes a factor relating to how a CTU is to be used. The factor relating to how the CTU is to be used can include any or some combination of the following: an expected travel distance of the CTU and an expected length of time that a customer plans to keep the CTU.

The expected travel distance of a CTU for a cargo delivery job can be considered by the CTU distributed management engine 104 to determine whether a given CTU is appropriate for the cargo delivery job. For example, an older CTU or a less maintained CTU may not be appropriate for a cargo delivery job that travels a long distance.

The expected length of time that a customer plans to keep the CTU can be considered by the CTU distributed management engine 104 to determine whether a given CTU is appropriate for the cargo delivery job. For example, the CTU may be a highly efficient CTU or the CTU may be a leased CTU where the lease is close to expiration (or the maximum miles per lease may have been exceeded, or the cost of the lease is greater compared to newer leases, etc.). If a customer (for a particular cargo delivery job) plans to keep the given CTU for a long time, then the given CTU may not be selected by the CTU distributed management engine 104 for the particular cargo delivery job since that may take a highly efficient CTU out of rotation, or the customer may keep the given CTU past the expiration of the lease.

In further examples, a target usage factor can include a general goal of minimizing or reducing cost. A cost calculation can be performed for each CTU. For example, various costs can be computed for a given CTU. A cost can be computed based on a distance of a CTU, such as a distance to pick up the CTU or distance to a repair facility (e.g., cost per mile).

Another cost can be based on an age of a CTU (e.g., an older CTU can cost more to maintain, while the older CTU may be associated with a smaller depreciation cost). A further cost can be based on a size of a CTU—a CTU that is too large for a given cargo job may mean that there is wasted space which may have been used for another cargo job. Alternatively, a CTU that is too small for a given cargo job may mean that the given cargo job has to be split among multiple jobs for transport by multiple CTUs. Another cost can relate to the cost of operating a CTU that is in poor repair or has a maintenance problem.

The various costs can be weighted, and a weighted sum (or other mathematical aggregate such as average, maximum, etc.) can be computed based on the costs and the weights associated with the costs. The CTU distribution management engine 104 can thus select a CTU based on a query for a cheapest CTU to operate for a given cargo job.

The CTU usage characteristics 122 and/or the target usage factors 124 can be considered individually by the CTU distributed management engine 104 in selecting CTUs for cargo delivery jobs, or alternatively, the CTU usage characteristics 122 and/or the target usage factors 124 can be considered in combination by the CTU distributed management engine 104 in selecting CTUs for cargo delivery jobs.

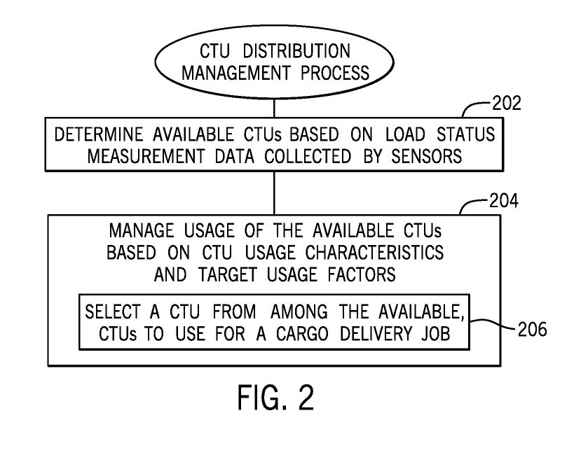

FIG. 2 is a flow diagram of a process that can be performed by the CTU distribution management engine 104 according to some examples. The CTU distribution management engine 104 determines (at 202) available CTUs 110 based on load status measurement data collected by sensors (e.g., sensors 116 in FIG. 1) indicating that the available CTUs are able to receive cargo.

The CTU distribution management engine 104 manages (at 204) usage of the available CTUs 110 based on the CTU usage characteristics 122 and the target usage factors 124 relating to the available CTUs. The managing of the usage of the available CTUs 110 can include selecting (at 206) a CTU from among the available CTUs to use for a cargo delivery job.

A load status can be derived based on measurement made by a sensor mounted on a CTU, where the load status can refer to whether or not the CTU contains any cargo items (i.e., the container is empty or the container contains at least one cargo item). The load status can also indicate an amount (e.g., percentage) of loading of the CTU. An available CTU is a CTU having a load status that indicates that the CTU still has capacity to receive more cargo item(s).

A sensor to measure a load status can include a Time-of-Flight (ToF) sensor. The ToF sensor is able to emit a signal (e.g., a light signal) that is reflected from a surface inside an inner chamber of a CTU. Based on the detection of the reflected signal by the ToF sensor, the sensor is able to determine a measurable feature that represents a distance between the ToF sensor and the surface (a CTU wall or a surface of a cargo item) in the CTU chamber that reflected the emitted signal. The measurable feature can be a distance between the ToF sensor and the surface in the CTU chamber. The measured distance indicates whether or not the CTU is loaded with cargo, and can also indicate the amount of cargo loading. In other examples, other types of sensors can be used to determine a load status of a CTU.

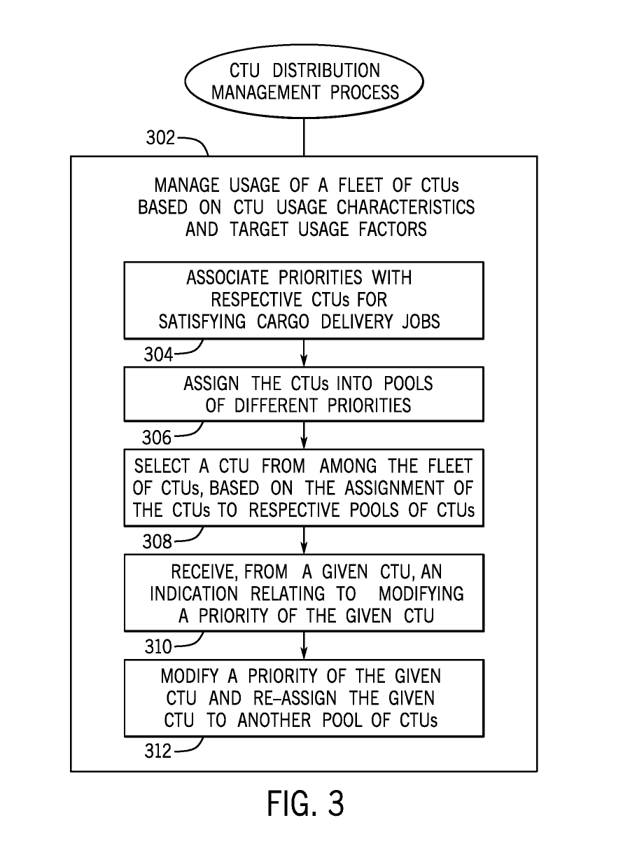

FIG. 3 is a flow diagram of a process performed by the CTU distribution management engine 104 according to further examples. The CTU distribution management engine 104 manages (at 302) usage of a fleet of CTUs 110 based on the CTU usage characteristics 122 and the target usage factors relating to the CTUs 110. The managing includes associating (at 304) priorities with respective CTUs 110 for satisfying cargo delivery jobs.

Associating priorities can include assigning indicators of priorities, where an indicator of priority can refer to a measure of priority (e.g., a higher value can indicate a higher priority while a lower value can indicate a lower priority, or vice versa), a rank value (a higher rank indicates a higher priority than a lower rank), and so forth. The CTU distribution management engine 104 can determine the priorities associated with the CTUs based on the CTU usage characteristics 122 and the target usage factors 124.

For example, a first CTU can be associated with a lower priority than a second CTU because the first CTU is older or has been less recently maintained than the second CTU, and a target usage factor being considered by the CTU distribution management engine 104 is a goal of reducing a distance to a repair facility. As another example, a first CTU can be associated with a higher priority than a second CTU because the first CTU has been idle for longer than the second CTU, and a target usage factor being considered by the CTU distribution management engine 104 is a goal of reducing downtime.

The managing further includes assigning (at 306) the CTUs 110 into pools of different priorities, based on the priorities associated with the CTUs 110. A first pool of CTUs can have a higher priority than a second pool of CTUs. There can be multiple different pools of CTUs that are associated with different priorities for different factors. For example, a first pool of CTUs (with lower priority) may include those CTUs that are older or that are less recently maintained when the target usage factor considered is the goal of reducing a distance to a repair facility, while a second pool of CTUs (with higher priority) may include those CTUs that are younger or more recently maintained. As another example, a third pool of CTUs (with higher priority) may include those CTUs less recently used when the target usage factor considered is the goal of reducing downtime, while a fourth pool of CTUs (with lower priority) may include those CTUs more recently used. Additional pools of CTUs of different priorities can be specified for different combinations of CTU usage characteristics and target usage factors.

The managing further includes selecting (at 308) a CTU from among the fleet of CTUs 110 for use for respective cargo delivery jobs, based on the assignment of the CTUs to respective pools of CTUs.

For example, if the CTU distribution management engine 104 is considering a target usage factor of reducing a distance to a repair facility, then the CTU distribution management engine 104 can select a CTU from a pool of CTUs ranked higher for that target usage factor. As another example, if the CTU distribution management engine 104 is considering a target usage factor of reducing downtime of a CTU, then the CTU distribution management engine 104 can select a CTU from a pool of CTUs ranked higher for this different target usage factor.

The managing further includes receiving (at 310), from a given CTU, an indication relating to modifying of a priority of the given CTU. The received indication relating to modifying the priority of the given CTU can be based on measurement data acquired by the one or more sensors 116 of the given CTU. For example, a sensor 116 of the given CTU can measure distance traveled. Another sensor 116 can detect that maintenance has been performed. Yet another sensor 116 can measure a wear level or fault of a component of the given CTU. For example, certain components (e.g., a brake, a tire, etc.) can wear out over time. A sensor 116 can detect such wear, and if the wear drops below a specified threshold, the CTU controller 112 (FIG. 1) in the given CTU can generate an indication of wear. Components can also exhibit fault. For example, a tire can lose pressure, a break can lose hydraulic fluid, a suspension can experience a mechanical failure, and so forth. A sensor 116 can be used to monitor for any such fault.

Based on such measurement data, the CTU controller 114 (FIG. 1) in the given CTU can determine that the priority of the given CTU should be changed. For example, based on distance traveled, the CTU controller 114 can send an indication to the CTU distribution management engine 104 that the given CTU should be placed into a lower priority pool of CTUs pertaining to the target usage factor of reducing usage of CTUs. As another example, based on detecting that maintenance has been performed, the CTU controller 114 can send an indication to the CTU distribution management engine 104 that the given CTU should be placed into a higher priority pool of CTUs pertaining to the target usage factor of reducing a distance to a repair facility. As a further example, based on detecting wear or fault of a component in the given CTU, the CTU controller 114 can send an indication to the CTU distribution management engine 104 that the given CTU should be placed into a lower priority pool of CTUs pertaining to the target usage factor of reducing a distance to a repair facility.

The indication that is sent can be a request to change a priority of the given CTU, or the changed priority itself, or any other information that is useable by the CTU distribution management engine 104 to change assignment of the given CTU among pools of CTUs of different priorities.

In response to the received indication, the CTU distribution management engine 104 modifies the priority of the given CTU and re-assigns (at 312) the given CTU to another pool of CTUs.

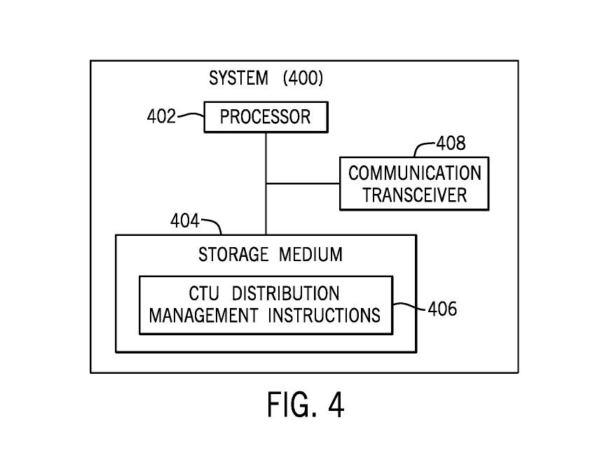

FIG. 4 is a block diagram of a system 400, which can be the system 102 of FIG. 1. The system 400 includes a processor 402 (or multiple processors). A processor can include a microprocessor, a core of a multi-core microprocessor, a microcontroller, a programmable integrated circuit, a programmable gate array, or another hardware processing circuit.

The system 400 further includes a non-transitory machine-readable or computer-readable storage medium 404 storing machine-readable instructions that are executable on the processor 402 to perform specified tasks. Instructions executable on a processor can refer to instructions executable on a single processor or multiple processors.

The machine-readable instructions include CTU distribution management instructions 406 that are executable on the processor 402 to perform the tasks discussed above, such as those of the CTU distribution management engine 104.

For example, the CTU distribution management instructions 406 can manage a distribution of usage of multiple CTUs based on usage characteristics of the multiple CTUs and target usage factors relating to the multiple CTUs, where the managing comprises selecting CTUs from among the multiple CTUs to use for respective cargo delivery jobs.

The system 400 further includes a communication transceiver 408 to perform communications over a network, such as the network 108 of FIG. 1.

The storage medium 404 can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A method comprising:
determining, by a system comprising a processor, available cargo transportation units (CTUs) based on load status measurement data collected by sensors indicating that the available CTUs are able to receive cargo; and
managing, by the system, usage of the available CTUs based on usage characteristics of the available CTUs and target usage factors relating to the available CTUs, wherein the managing comprises:
selecting a CTU from among the available CTUs to use for a cargo delivery job.

2. The method of claim 1, wherein the usage characteristics of the available CTUs are selected from among an age of a CTU, a time since a most recent use of a CTU, a maintenance status of a CTU, a frequency of use of a CTU, and a lease status of a CTU.

3. The method of claim 1, wherein the target usage factors are selected from among a goal of reducing a downtime of a CTU, a goal of reducing a distance to a repair facility of a CTU, a goal of reducing a distance to pick up a CTU, a goal of reducing usage of a CTU, a goal of increasing usage of a CTU, and a goal of balancing usage of CTUs in a fleet.

4. The method of claim 1, wherein the target usage factors comprise a factor relating to how a CTU is to be used.

5. The method of claim 4, wherein the factor relating to how the CTU is to be is selected from among an expected travel distance of the CTU and an expected length of time that a customer plans to keep the CTU.

6. The method of claim 1, wherein the target usage factors comprise a factor relating to reducing a cost of using a CTU.

7. The method of claim 1, further comprising:
associating priorities with respective available CTUs for satisfying jobs for delivering cargo,
wherein the selecting is based on the priorities.

8. The method of claim 7, further comprising:
receiving, from a given CTU of the available CTUs, an indication relating to modifying a priority of the given CTU.

9. The method of claim 8, wherein the received indication is based on measurement data acquired by one or more sensors of the given CTU.

10. The method of claim 7, further comprising:
assigning the available CTUs into pools of different priorities, based on the priorities associated with the available CTUs.

11. A system comprising:
at least one processor configured to:
determine available cargo transportation units (CTUs) based on load status measurement data collected by sensors indicating that the available CTUs are able to receive cargo; and
manage usage of the available CTUs based on usage characteristics of the available CTUs and target usage factors relating to the available CTUs, wherein the managing comprises associating different priorities with the available CTUs for respective cargo delivery jobs.

12. The system of claim 11, wherein the at least one processor is configured to modify a priority of a given CTU of the available CTUs responsive to an indication received from the given CTU, the indication based on measurement data from a sensor of the given CTU.

13. The system of claim 12, wherein the at least one processor is configured to modify a priority associated with the given CTU in response to the indication indicating wear or fault of a component of the given CTU.

14. The system of claim 12, wherein the at least one processor is configured to modify a priority of the given CTU responsive to the indication indicating a change in a maintenance status of the given CTU.

15. The system of claim 12, wherein the at least one processor is configured to modify a priority of the given CTU responsive to the indication indicating an amount of distance traveled.

16. The system of claim 11, wherein the usage characteristics of the available CTUs are selected from among an age of a CTU, a time since a most recent use of a CTU, a maintenance status of a CTU, a frequency of use of a CTU, and a lease status of a CTU.

17. The system of claim 11, wherein the target usage factors are selected from among a goal of reducing a downtime of a CTU, a goal of reducing a distance to a repair facility of a CTU, a goal of reducing a distance to pick up a CTU, a goal of reducing usage of a CTU, a goal of increasing usage of a CTU, and a goal of balancing usage of CTUs in a fleet.

18. The system of claim 11, wherein the target usage factors comprise a factor selected from among an expected travel distance of a CTU and an expected length of time that a customer plans to keep a CTU.

19. A non-transitory machine-readable storage medium storing instructions that upon execution cause a system to:
determine available cargo transportation units (CTUs) based on load status measurement data collected by sensors indicating that the available CTUs are able to receive cargo; and
manage a distribution of usage of the available CTUs based on usage characteristics of the available CTUs and target usage factors relating to the available CTUs, wherein the managing comprises selecting CTUs from among the available CTUs to use for respective cargo delivery jobs.

20. The non-transitory machine-readable storage medium of claim 19, wherein the managing further comprises:
assigning subsets of the available CTUs to respective pools of CTUs of different priorities,
wherein the selecting is based on the assignment of CTUs to the pools.

21. The non-transitory machine-readable storage medium of claim 20, wherein the managing further comprises:
modify a priority of a given CTU of the available CTUs responsive to an indication received from the given CTU, the indication based on measurement data from a sensor of the given CTU, and
re-assign the given CTU to a different pool of CTUs based on the modified priority.
